(19) United States
(12) Patent Application Publication
(10) Pub. No.: US 2012/0162208 A1
(43) Pub. Date: Jun. 28, 2012

(54) 2D/3D IMAGE DISPLAY DEVICE

(75) Inventors: Jong-Woong PARK, Yongin-city (KR); Joo-Hyung LEE, Yongin-city (KR); Geun-Young JEONG, Yongin-city (KR); Ji-Yeon YANG, Yongin-city (KR); Byung-Ki CHUN, Yongin-city (KR)

(73) Assignee: Samsung Mobile Display Co., Ltd., Yongin-city (KR)

(21) Appl. No.: 13/314,800

(22) Filed: Dec. 8, 2011

(30) Foreign Application Priority Data
Dec. 22, 2010 (KR) 10-2010-0132437

(51) Int. Cl. G06T 15/00

(52) U.S. Cl. 345/419

(57) ABSTRACT

A two-dimensional (2D)/three-dimensional (3D) image display device is disclosed. The 2D/3D image display device includes pixels each having a first subpixel and a second subpixel, wherein, in a 2D driving mode, the first subpixel and the second subpixel respectively display images for a same image signal based on data voltages corresponding to different gamma curves.

### CROSS-REFERENCE TO RELATED APPLICATION

This application claims priority from Korean Patent Application No. 10-2010-0132437 filed on Dec. 22, 2010 in the Korean Intellectual Property Office, the disclosure of which is incorporated herein by reference in its entirety.

### BACKGROUND

1. Field

The disclosed technology relates to a two-dimensional (2D)/three-dimensional (3D) image display device, and more particularly, to a 2D/3D image display device having improved lateral visibility in a 2D driving mode.

2. Description of the Related Technology

In general, primary factors that cause a human to perceive stereoscopic depth perception are a physiological factor and an experiential factor. In a three-dimensional (3D) image displaying technology, binocular parallax is generally used to express the stereoscopic effect of an object. The binocular parallax is a primary factor of recognizing the stereoscopic effect at short distances.

In order to display a stereoscopic image, a display device spatially divides a left image and a right image using optical elements. Representatively, a lenticular lens array or a parallax barrier has been used.

Recently, stereoscopic image display devices capable of displaying both a two-dimensional (2D) image and a 3D image have been developed and commercialized. In a 2D driving mode, however, the lateral visibility of a 2D/3D image display device capable of selectively displaying a 2D image and 3D image can be improved.

### SUMMARY OF CERTAIN INVENTIVE ASPECTS

One inventive aspect is a two-dimensional (2D)/three-dimensional (3D) image display device. The display device includes a plurality of gate lines extending in a first direction and transmitting gate signals, a plurality of data lines extending in a second direction that intersects the first direction and applying transmitting data voltages corresponding to input image signals, and a plurality of unit pixels formed in regions defined by near intersections of the gate lines and the data lines. Each of the unit pixels includes a first subpixel and a second subpixel, where, in a 2D driving mode, the first subpixel and the second subpixel respectively display images for a same image signal while according to first and second 2D data voltages corresponding to different gamma curves are applied to the first subpixel and the second subpixel, respectively.

Another inventive aspect is a 2D/3D image display device. The display device includes a plurality of gate lines extending in a first direction and transmitting gate signals, a plurality of data lines extending in a second direction that intersects the first direction and applying transmitting data voltages corresponding to input image signals, a first subpixel connected to an i-th gate line and a j-th data line, and a second subpixel connected to an (i+1)-th gate line and the j-th data line. A first data voltage is applied to the first subpixel, and a second data voltage is applied to the second subpixel, where, in a 2D driving mode, the first data voltage is a voltage corresponding corresponds to any one of a high gamma curve and a low gamma curve and the second data voltage is a voltage corresponding corresponds to the other one of the high gamma curve and the low gamma curve. In a 3D driving mode, the first data voltage is a voltage corresponding corresponds to any one of a left-eye image signal and a right-eye image signal and the second data voltage is a voltage corresponding corresponds to the other one of the left-eye image signal and the right-eye image signal.

### BRIEF DESCRIPTION OF THE DRAWINGS

FIG. 1 is a cross-sectional view of a two-dimensional (2D)/three-dimensional (3D) image display device according to an exemplary embodiment;

FIG. 2 is a plan view of pixels arranged in the 2D/3D image display device according to the exemplary embodiment of FIG. 1;

FIG. 3 is a block diagram for explaining a method of driving the 2D/3D image display device according to the exemplary embodiment of FIG. 1;

FIG. 4 is an equivalent circuit diagram of one unit pixel of the 2D/3D image display device according to the exemplary embodiment of FIG. 1;

FIGS. 5 and 6 are equivalent circuit diagrams of one unit pixel for explaining 2D and 3D driving modes of the 2D/3D image display device according to the exemplary embodiment of FIG. 1.

FIG. 7 is an equivalent circuit diagram of one unit pixel of a 2D/3D image display device according to another exemplary embodiment; and

FIG. 8 is a cross-sectional view of a 2D/3D image display device according to another exemplary embodiment.

### DETAILED DESCRIPTION OF CERTAIN INVENTIVE EMBODIMENTS

Certain advantages and features may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete.

In the drawings, sizes and relative sizes of elements may be exaggerated for clarity. Like reference numerals generally refer to like elements throughout the specification. As used herein, the term “and/or” includes any and all combinations of one or more of the associated listed items.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” and/or “made of,” when used in this specification, specify the presence of stated components, steps, operations, and/or elements, but do not preclude the presence or addition of one or more other components, steps, operations, elements, and/or groups thereof.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings.

Embodiments are described herein with reference to plan and cross-section illustrations that are schematic illustrations of idealized embodiments. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

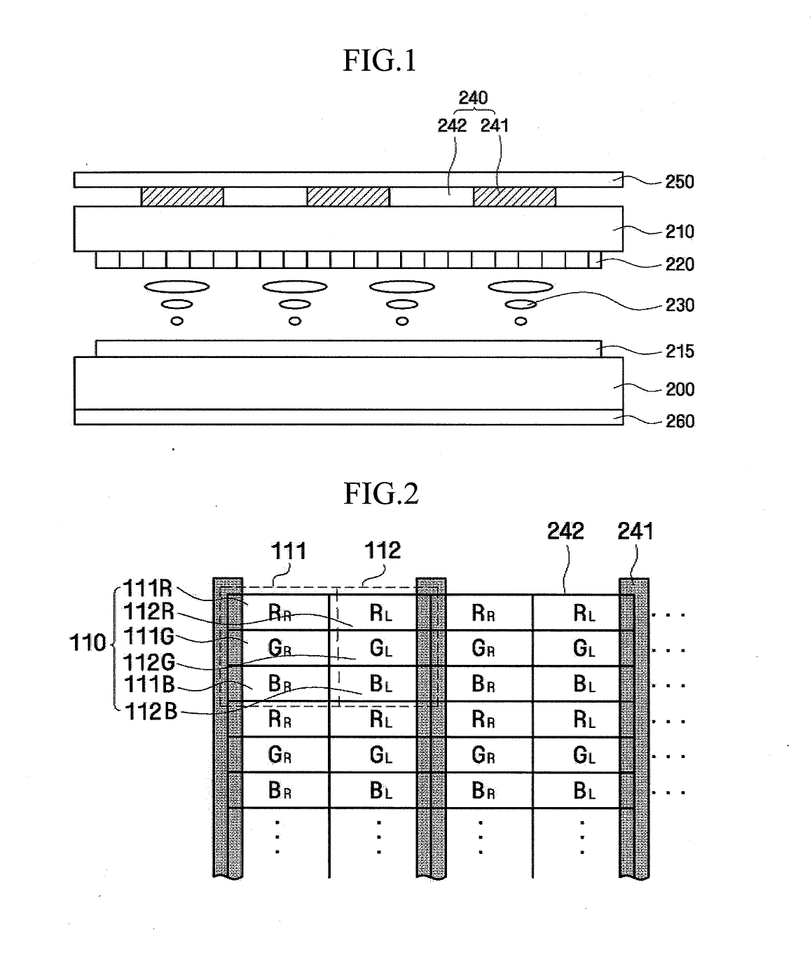

Hereinafter, a two-dimensional (2D)/three-dimensional (3D) image display device according to an exemplary embodiment is described with reference to FIGS. 1 and 2. FIG. 1 is a cross-sectional view of a 2D/3D image display device according to an exemplary embodiment. FIG. 2 is a plan view of pixels arranged in the 2D/3D image display device according to the exemplary embodiment of FIG. 1.

Referring to FIG. 1, a liquid crystal layer 230 is disposed between a first substrate 200 and a second substrate 210. A thin-film transistor (TFT) array layer 215 is disposed on a first surface of the first substrate 200 which faces the liquid crystal layer 230. The TFT array layer 215 includes a plurality of pixel electrodes arranged in a matrix pattern, TFTs applying driving voltages respectively to the pixel electrodes, and signal lines for operating the TFTs.

A common electrode (not shown) which is transparent and conductive is formed on substantially the entire first surface of the second substrate 210 which faces the liquid crystal layer 230. Also, color filters 220 are formed on the first surface of the second substrate 210 to face the pixel electrodes, respectively. The color filters 220 include, for example, a red color filter, a green color filter, and a blue color filter.

The liquid crystal layer 230 is modified according to an electric field generated between the pixel electrodes and the common electrode. The liquid crystal layer 230 adjusts its transmittance of light applied from an external source, and an image is displayed when the light with the adjusted transmittance passes through the color filters 220.

A first polarizing plate 260 is disposed on a second surface of the first substrate 200 which is opposite the first surface of the first substrate 200 on which the TFT array layer 215 is disposed. In addition, a second polarizing plate 250 is disposed on a second surface of the second substrate 210 which is opposite the first surface of the second substrate 210 on which the color filters 220 are disposed.

A barrier layer 240 is disposed between the second surface of the second substrate 210 and the second polarizing plate 250. The barrier layer 240 is an optical isolator that allows a left-eye image and a right-eye image to be observed separately. The barrier layer 240 includes light-blocking film patterns 241 and light-transmitting portions 242 arranged alternately. The light-blocking film patterns 241 are formed by coating a material for forming the light-blocking film patterns 241 on the second surface of the second substrate 210. Therefore, the light-blocking film patterns 241 are in contact with the second surface of the second substrate 210. In addition, regions blocked from light by the light-blocking film patterns 241 are fixed.

The material that forms the light-blocking film patterns 241 may include light-blocking resin or light-blocking metal. The light-blocking resin may be resin (such as carbon black) for forming an organic black matrix, and the light-blocking metal may be chrome.

Referring to FIG. 2, one unit pixel 110 includes a first subpixel 111 and a second subpixel 112. The first and second subpixels 111 and 112 are arranged alternately along a first direction (e.g., a row direction). The area of the first subpixel 111 is equal to that of the second subpixel 112.

The first subpixel 111 may include a red first subpixel 111R, a green first subpixel 111G, and a blue first subpixel 111B. The second subpixel 112 may include a red second subpixel 112R, a green second subpixel 112G, and a blue second subpixel 112B. The red first subpixel 111R, the green first subpixel 111G, and the blue first subpixel 111B are arranged along a second direction (e.g., a column direction) that intersects the first direction. First and second subpixels of the same color are arranged alternately along the first direction. For example, the red first subpixel 111R and the red second subpixel 112R are arranged alternately along the first direction.

The light-blocking film patterns 241 of the barrier layer 240 extend in the second direction and are arranged alternately with the light-transmitting portions 242 along the first direction.

The first subpixel 111 may, for example, be a right-eye subpixel and the second subpixel 112 may be a left-eye subpixel. In a 3D driving mode, a right-eye image is displayed on the first subpixel 111 in response to a right-eye image signal, and a left-eye image is displayed on the second subpixel 112 in response to a left-eye image signal. Light from the first subpixel 111 passes through the light-transmitting portions 242 to reach the right eye of an observer, and light from the second subpixel 112 passes through the light-transmitting portions 242 to reach the left eye of the observer. On the other hand, light from the first subpixel 111 travelling toward the left eye of the observer is blocked by the light-blocking film patterns 241. In addition, light from the second subpixel 112 travelling toward the right eye of the observer is blocked by the light-blocking film patterns 241.

In a 2D driving mode, the first subpixel 111 and the second subpixel 112 respectively display images based on the same image signal. However, data voltages corresponding to different gamma curves are applied to the first subpixel 111 and the second subpixel 112, respectively, in order to improve lateral visibility, as will be described later. Therefore, the luminance of the first subpixel 111 is different from that of the second subpixel 112.

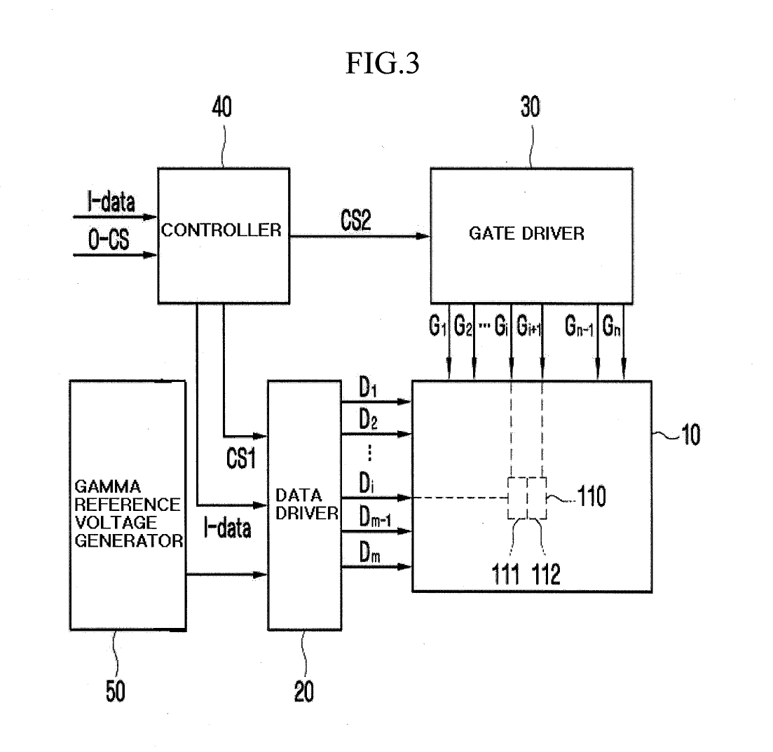

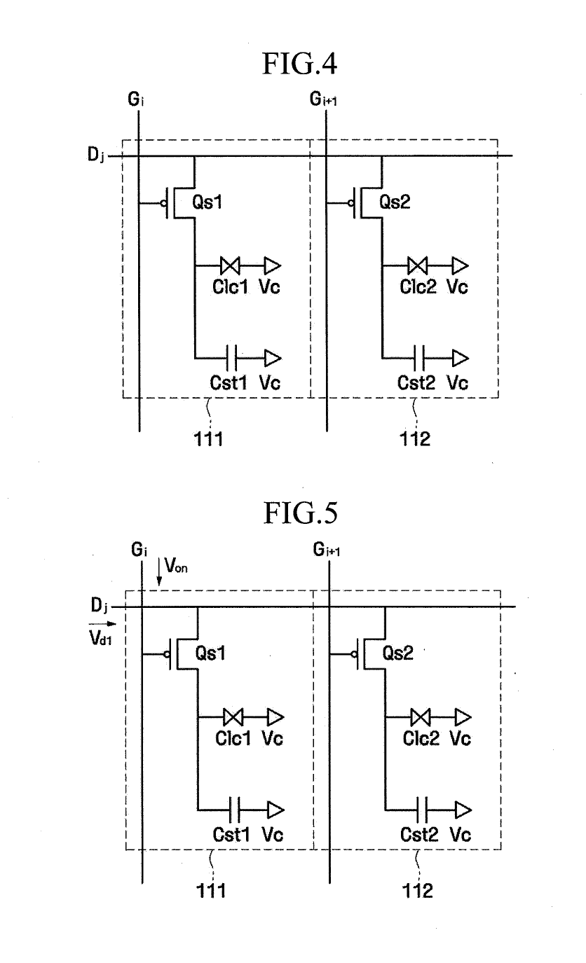

Hereinafter, a method of driving the 2D/3D image display device according to the exemplary embodiment of FIGS. 1 and 2 will be descried with reference to FIGS. 3 and 4. FIG. 3 is a block diagram for explaining a method of driving the 2D/3D image display device according to the exemplary embodiment of FIG. 1. FIG. 4 is an equivalent circuit diagram of one unit pixel of the 2D/3D image display device according to the exemplary embodiment of FIG. 1.

Referring to FIG. 3, the 2D/3D image display device according to the exemplary embodiment of FIG. 1 includes a display panel 10, a data driver 20, a gate driver 30, a controller 40, and a gamma reference voltage generator 50.

The display panel 10 includes a plurality of gate lines G₁ through Gₙ and a plurality of data lines D₁ through Dₘ. The display panel 10 is divided into a plurality of pixel regions arranged in a matrix pattern by the gate lines G₁ through Gₙ and the data lines D₁ through Dₘ, and the unit pixel 110 including the first subpixel 111 and the second subpixel 112 is formed in each of the pixel regions. The gate lines G₁ through Gₙ extend in the first direction and are substantially parallel to each other. The data lines D₁ through Dₘ extend in the second direction that intersects the first direction and are substantially parallel to each other.

Referring to FIG. 4, the first subpixel 111 includes a first TFT Qs1 and a first liquid crystal capacitor Clc1, and the second subpixel 112 includes a second TFT Qs2 and a second liquid crystal capacitor Clc2. The first and second subpixels 111 and 112 are connected to first and second gate lines Gᵢ and Gᵢ₊₁, respectively, and are connected to the first data line Dⱼ. Specifically, the first TFT Qs1 has a control electrode connected to the first gate line Gᵢ, an input electrode connected to the first data line Dⱼ, and an output electrode connected to a first subpixel electrode which is a first electrode of the first liquid crystal capacitor Clc1. In addition, the second TFT Qs2 has a control electrode connected to the second gate line Gᵢ₊₁, an input electrode connected to the first data line Dⱼ, and an output electrode connected to a second subpixel electrode which is a first electrode of the second liquid crystal capacitor Clc2. Here, a second electrode of each of the first and second liquid crystal capacitors Clc1 and Clc2 is the common electrode.

Referring back to FIG. 3, the controller 40 receives an image signal I-data and various control signals O-CS from an external graphics controller (not shown). The controller 40 receives various control signals O-CS, such as a vertical synchronization signal, a horizontal synchronization signal, a main clock and a data enable signal, and outputs a first control signal CS1 and a second control signal CS2. The image signal I-data is transmitted to the data driver 20 in synchronization with the first control signal CS1, and the second control signal CS2 is transmitted to the gate driver 30.

The first control signal CS1 controls the operation of the data driver 20, and examples of the first control signal CS1 include a horizontal start signal, an inversion signal, and an output instruction signal. The second control signal CS2 controls the operation of the gate driver 30, and examples of the second control signal CS2 include a vertical start signal, a gate clock signal, and an output enable signal.

The gate driver 30 receives a gate-on voltage Von and a gate-off voltage Voff from an external source and outputs gate voltages sequentially in response to the second control signal CS2 from the controller 40. The gate driver 30 is electrically connected to the gate lines G₁ through Gₙ of the display panel 10.

The data driver 20 receives the image signal I-data in synchronization with the first control signal CS1, converts the image signal I-data into a data voltage, and outputs the data voltage. The data driver 20 is electrically connected to the data lines D₁ through Dₘ of the display panel 10.

The gamma reference voltage generator 50 outputs a high gamma reference voltage corresponding to a high gamma value or a low gamma reference voltage corresponding to a low gamma value. The high gamma value and the low gamma value are relative to each other.

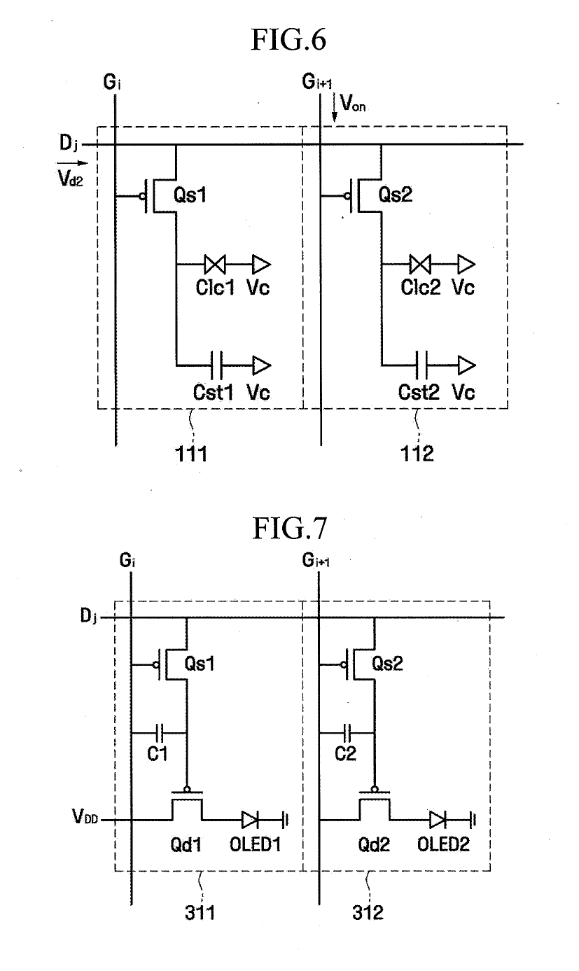

The 2D and 3D driving modes of the 2D/3D image display device according to the exemplary embodiment of FIG. 1 is described with reference to FIGS. 3, 5 and 6. FIGS. 5 and 6 are equivalent circuit diagrams of one unit pixel for explaining the 2D and 3D driving modes of the 2D/3D image display device according to the exemplary embodiment of FIG. 1.

First, the 2D driving mode is described. In the 2D driving mode, the gamma reference voltage generator 50 outputs a high gamma reference voltage during a time period in which the first subpixel 111 is turned on by the application of the gate-on voltage Von to, e.g., the first gate line Gᵢ. In contrast, the gamma reference voltage generator 50 outputs a low gamma reference voltage during a time period in which the second subpixel 112 is turned on by the application of the gate-on voltage Von to the second gate line Gᵢ₊₁.

During the time period in which the first subpixel 111 is turned on, the data driver 20 converts the image signal I-data into a first data voltage V_{d1} based on the high gamma reference voltage and outputs the first data voltage V_{d1}. During the time period in which the second subpixel 112 is turned on, the data driver 20 converts the image signal I-data into a second data voltage V_{d2} based on the low gamma reference voltage and outputs the second data voltage V_{d2}. The first data voltage V_{d1} is a voltage corresponding to a high gamma curve having a high gamma value, and the second data voltage V_{d2} is a voltage corresponding to a low gamma curve having a low gamma value. Here, the level of the first data voltage V_{d1} is higher than that of the second data voltage V_{d2}.

Alternatively, the gamma reference voltage generator 50 may output a low gamma reference voltage during the time period in which the first subpixel 111 is turned on and output a high gamma reference voltage during the time period in which the second subpixel 112 is turned on. During the time period in which the first subpixel 111 is turned on, the data driver 20 converts the image signal I-data into the first data voltage V_{d1} based on the low gamma reference voltage and outputs the first data voltage V_{d1}. During the time period in which the second subpixel 112 is turned on, the data driver 20 converts the image signal I-data into the second data voltage V_{d2} based on the high gamma reference voltage and outputs the second data voltage V_{d2}. The first data voltage V_{d1} is a voltage corresponding to a low gamma curve having a low gamma value, and the second data voltage V_{d2} is a voltage corresponding to a high gamma curve having a high gamma value. Here, the level of the first data voltage V_{d1} is lower than that of the second data voltage V_{d2}.

When the first subpixel 111 is turned on by the application of the gate-on voltage Von to the first gate line Gᵢ, the first data voltage V_{d1} is applied to the first data line Dⱼ. When the second subpixel 112 is turned on by the application of the gate-on voltage Von to the second gate line Gᵢ₊₁, the second data voltage V_{d2} is applied to the first data line V_{d1}. Consequently, the lateral visibility of the 2D/3D image display device in the 2D driving mode can be improved by applying data voltages corresponding to different gamma curves to the first subpixel 111 and the second subpixel 112, respectively.

The 3D image display mode is next described. The image signal I-data input to the data driver 20 includes a left-eye image signal and a right-eye image signal. The data driver 20 converts each of the left-eye image signal and the right-eye image signal into a data voltage and outputs the data voltage.

During the time period in which the first subpixel 111 is turned on, the data driver 20 converts any one (e.g., the left-eye image signal) of the left-eye image signal and the right-eye image signal into the first data voltage V_{d1} and outputs the first data voltage V_{d1}. The first data voltage V_{d1} is applied to the first data line Dⱼ, and a left-eye image is displayed on the first subpixel 111. During the time period in which the second subpixel 112 is turned on, the data driver 20 converts the other one (e.g., the right-eye image signal) of the left-eye image signal and the right-eye image signal into the second data voltage V_{d2} and outputs the second data voltage V_{d2}. The second data voltage V_{d2} is applied to the first data line and a right-eye image is displayed on the second subpixel 112. In some embodiments, no gamma correction is used.

Hereinafter, a 2D/3D image display device according to another exemplary embodiment is described with reference to FIG. 7. FIG. 7 is an equivalent circuit diagram of one unit pixel of a 2D/3D image display device according to another exemplary embodiment of the present invention.

The 2D/3D image display device according to the current exemplary embodiment is similar to the 2D/3D image display device according to the previous exemplary embodiment. However, the display panel of this embodiment includes organic light-emitting diodes (OLEDs). The following description will emphasize the differences between the embodiments.

Referring to FIG. 7, a first subpxiel 311 includes a first switching TFT Qs1, a first driving TFT Qd1, a first capacitor C1, and a first OLED OLED1. The second subpixel 312 includes a second switching TFT Qs2, a second driving TFT Qd2, a second capacitor C2, and a second OLED OLED2.

The first and second subpixels 311 and 312 are connected to first and second gate lines Gᵢ and Gᵢ₊₁, respectively, and are connected to a first data line D. Specifically, the first switching TFT Qs1 has a control electrode connected to the first gate line Gᵢ, an input electrode connected to the first data line Dⱼ, and an output electrode connected to a control electrode of the first driving TFT Qd1. An input electrode of the first driving TFT Qd1 is connected to a driving voltage V_{DD}, and an output voltage of the first driving TFT Qd1 is connected to the first OLED OLED1. The first capacitor C1 is connected between the control electrode and the input electrode of the first driver TFT Qd1. In addition, the second switching TFT Qs2 has a control electrode connected to the second gate line Gᵢ₊₁, an input electrode connected to the first data line and an output electrode connected to a control electrode of the second driving TFT Qd2. An input electrode of the second driving TFT Qd2 is connected to the driving voltage V_{DD}, and an output electrode of the second driver TFT Qd2 is connected to the second OLED OLED2. The second capacitor C2 is connected between the control electrode and the input electrode of the second driver TFT Qd2.

Each of the first and second driving TFTs Qd1 and Qd2 allows an electric current which varies in magnitude according to the voltage applied between the control electrode and the input electrode to flow therethrough. The first and second capacitors C1 and C2 are charged with data voltages applied to the control electrodes of the first and second driving TFTs Qd1 and Qd2, and the data voltages are maintained even after the first and second switching TFTs Qs1 and Qs2 are turned off.

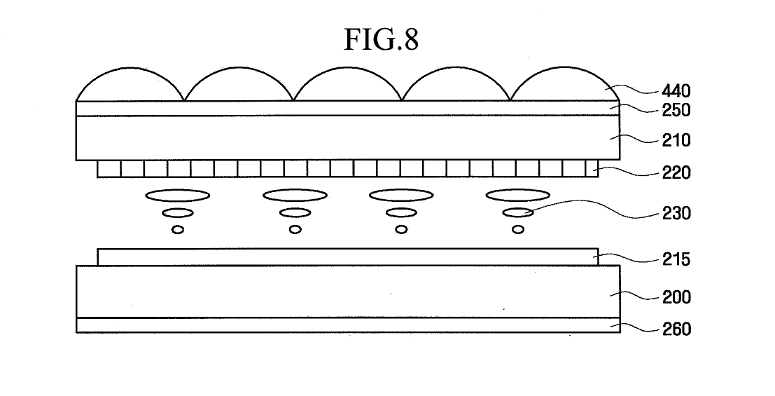

Hereinafter, a 2D/3D image display device according to another exemplary embodiment of is described with reference to FIG. 8. FIG. 8 is a cross-sectional view of a 2D/3D image display device according to another exemplary embodiment. Elements similar to those illustrated in FIG. 1 are indicated by like reference numerals, and a detailed description thereof is omitted.

Referring to FIG. 8, the 2D/3D image display device according to the current exemplary embodiment is different from the 2D/3D image display device according to the exemplary embodiment of FIG. 1 in that a microlens array 440, instead of a barrier layer 240 (see FIG. 1), is used as an optical isolator. The microlens array 440 may be disposed on a second polarizing plate 250.

While certain aspects and features have been shown and described with reference to exemplary embodiments, it will be understood by those of ordinary skill in the art that various changes in form and detail may be made without departing from the spirit and scope of the present invention. The exemplary embodiments should be considered in a descriptive sense only and not for purposes of limitation.

What is claimed is:

1. A two-dimensional (2D)/three-dimensional (3D) image display device comprising:
a plurality of gate lines extending in a first direction and transmitting gate signals;
a plurality of data lines extending in a second direction that intersects the first direction and transmitting data voltages corresponding to input image signals; and
a plurality of pixels formed in regions near intersections of the gate lines and the data lines, wherein each of the unit pixels comprises a first subpixel and a second subpixel, wherein, in a 2D driving mode, the first subpixel and the second subpixel respectively display images for a same image signal according to first and second 2D data voltages corresponding to different gamma curves applied to the first subpixel and the second subpixel, respectively.

2. The display device of claim 1, wherein the area of the first subpixel is equal to the area of the second subpixel.

3. The display device of claim 2, wherein the first and second 2D data voltages are different.

4. The display device of claim 1, wherein, in a 3D driving mode, a first 3D data voltage corresponding to one of a left-eye image signal and a right-eye image signal is applied to the first subpixel, and a second 3D data voltage corresponding to the other one of the left-eye image signal and the right-eye image signal is applied to the second subpixel.

5. The display device of claim 1, wherein the first subpixel is connected to an i-th gate line and a j-th data line, and the second subpixel is connected to an (i+1)-th gate line and the j-th data line.

6. The display device of claim 1, wherein the first subpixel and the second subpixel are arranged alternately along the second direction.

7. The display device of claim 6, wherein each of the pixels comprises a blue subpixel, a green subpixel, and a red subpixel, wherein the blue subpixel, the green subpixel, and the red subpixel are arranged along the first direction.

8. The display device of claim 6, further comprising a barrier layer which comprises light-blocking film patterns and light-transmitting portions extending in the first direction and arranged alternately along the second direction.

9. The display device of claim 8, wherein the light-blocking film patterns are formed by coating a material for forming the light-blocking film patterns on a surface.

10. The display device of claim 9, wherein the material for forming the light-blocking film patterns comprises a light-blocking resin.

11. The display device of claim 1, further comprising a microlens array over the pixels.

12. A 2D/3D image display device comprising:
a plurality of gate lines extending in a first direction and transmitting gate signals;
a plurality of data lines extending in a second direction that intersects the first direction and transmitting data voltages corresponding to input image signals;
a first subpixel connected to an i-th gate line and a j-th data line; and
a second subpixel connected to an (i+1)-th gate line and the j-th data line,
wherein a first data voltage is applied to the first subpixel, and a second data voltage is applied to the second subpixel, wherein, in a 2D driving mode, the first data voltage corresponds to one of a high gamma curve and a low gamma curve and the second data voltage corresponds to the other of the high gamma curve and the low gamma curve, and, in a 3D driving mode, the first data voltage corresponds to one of a left-eye image signal and a right-eye image signal and the second data voltage corresponds to the other of the left-eye image signal and the right-eye image signal.

13. The display device of claim 12, wherein a voltage corresponding to the high gamma curve is higher than a voltage corresponding to the low gamma curve.

14. The display device of claim 12, wherein, in the 2D driving mode, a luminance of the first subpixel is different from that of the second subpixel.

15. The display device of claim 12, further comprising:
a controller receiving an image signal and external control signals from an external source, generating first and second control signals, and outputting the image signal synchronized with the first control signal;
a data driver receiving the image signal, converting the image signal into the first and second data voltages, and outputting the first and second data voltages; and
a gate driver outputting a gate-on voltage synchronized with the second control signal.

16. The display device of claim 15, further comprising a gamma reference voltage generator outputting a high gamma reference voltage or a low gamma reference voltage to the data driver.
